(19) United States
(12) Patent Application Publication
(10) Pub. No.: US 2003/0178251 A1
(43) Pub. Date: Sep. 25, 2003

(54) Self-elevating tree stand

(76) Inventor: Mark E. Hewitt, Orlando, FL (US)

Correspondence Address: Elsie C. Turner, Suite 204, 201 Park Place, Altamonte Springs, FL, 32701, US

(21) Appl. No.: 10/101,804

(22) Filed: Mar. 21, 2002

(51) Int. Cl. A01M 31/02

(52) U.S. Cl. 182/63.1; 182/127

(57) ABSTRACT

A self-elevating, wheeled, trailerable, collapsible and adjustable tree-stand having a stable and secure platform and collapsible rotating seat is provided. A vertical frame member supports the platform, seat, and upper and lower rectangular frames of adjustable depth, in parallel horizontal planes, which enclose and brace a tree to be climbed. The upper and lower rectangular frames support rollers which enable the stand to glide smoothly up and down the tree. A removable rear bar of each rectangular frame can be set at varying depths on the side bars of the frame to accommodate varying diameters of trees. The stand is elevated by retraction of a cable by a motorized winch mounted on the platform. The cable hooks onto an upper support belt member fastened around the tree. The upper support belt member includes a belt-cinching assembly and is positioned by the user at a point above his head but within his reach. After raising the stand to this point, the user may gain additional height by tightening a lower support belt member, also with belt-cinching assembly, to secure the stand while releasing the upper support belt member to move it higher on the tree. Both belt members are equipped with tree glides which provide ease of sliding movement over the rough bark of a tree.

### BACKGROUND OF THE INVENTION

1. Field of the Invention

The present invention relates to an adjustable, power-driven, trailerable climbing tree stand for attachment to trees.

2. Background of the Invention

Various devices are known for comfortably supporting a hunter, photographer or wildlife observer in an elevated position providing greater unobstructed vision while removing the user from the visual and scent range of wildlife, as well as safety. The bulk of these devices require the user to first climb the tree and place a support belt or cable high around the tree, to which cable is attached means for hoisting the stand.

U.S. Pat. No. 6,079,517 to Payne is for a power-driven climbing tree stand adapted to receive a wheel chair. It can be elevated by a user sitting in the wheel chair while the stand is on the ground. It incorporates a winch and hoisting cable attached to a tree-surrounding support cable in a noose arrangement whereby the retraction of the hoisting cable by the winch causes the support cable to engage the tree like a lasso or lariat. The user elevates the support cable to the desired height on the tree, from a wheel chair resting on the stand, using a rod with cable-positioning member, then operates the winch to retract the hoisting cable and elevate the stand. One or more tree-puncturing locking pins serve to anchor the tree stand to the tree after it has been hoisted to the desired level, which may be an intermediate or final height. Upon securing the stand with the tree-puncturing pin(s), the user may release the tension on the hoisting cable, reposition the support cable higher on the tree, and then operate the winch to hoist the tree stand to the higher level. This invention has several disadvantages. First of all, the locking pins cause damage to trees. In some publicly-owned forests, it is now forbidden to use any device that penetrates trees. Secondly, the lasso-like mechanism of the elevator system has no horizontal circular force vector around the tree independent of the winch to secure the tree-surrounding cable to the tree. If the loop of the lasso should slip on the tree while the tree stand is being lifted by the winch assembly, it could come tumbling down, since the locking pin(s) must be released in order for the tree stand to be raised. Thirdly, the invention does not appear to be adjustable to snugly fit varying diameters of trees.

U.S. Pat. No. 6,182,792 to Woller et al. is for a device purporting to be a climbing tree stand which is secured in place by tightening a tree-surrounding support cable. However it has no elevator means. In order to raise it to a higher position on a tree from a lower elevation, the user would have to attach block and tackle or other means attached to the tree at the higher position in order to be able to release the cable and lift the stand.

U.S. Pat. No. 4,811,803 to Green is for a self-propelled deer stand for elevating the user above the ground. It is adjustable to the diameter of the tree trunk and incorporates rollers so that the stand may easily ride up the tree while bracing the stand against the tree. It relies on a motorized winch and cable assembly to lift the stand, but the user must first climb the tree, fasten a supporting belt around the trunk or a strong limb, and attach the hoisting cable to the supporting belt. After lowering the tree stand to the ground, the user must again climb the tree in order to remove the hoisting cable and the supporting belt. It has no means to support the stand in an elevated position while the user moves the supporting belt to a higher position.

Accordingly there is a need to provide an adjustable self-elevating tree stand that does not puncture the trees it climbs, that provides adequate securing means to prevent the tree stand from falling down and injuring the user, and that eliminates the need for the user to climb the tree before raising and after lowering the stand.

### SUMMARY OF THE INVENTION

The present invention provides a self-elevating, wheeled, trailerable, collapsible and adjustable tree-stand having a stable and secure platform and collapsible rotating seat. A vertical frame member supports the platform, seat, and upper and lower rectangular frames of adjustable depth, in parallel horizontal planes, which enclose and brace a tree to be climbed. The upper and lower rectangular frames support rollers which enable the stand to glide smoothly up and down the tree. A removable rear bar of each rectangular frame can be set at varying depths on the side bars of the frame to accommodate varying diameters of trees. The stand is elevated by retraction of a cable by a motorized winch mounted on the platform. The cable hooks onto an upper support belt member fastened around the tree. The upper support belt member includes a belt-cinching assembly and is positioned by the user at a point above his head but within his reach. After raising the stand to this point, the user may gain additional height by tightening a lower support belt member, also with belt-cinching assembly, to secure the stand while releasing the upper support belt member to move it higher on the tree. Both belt members are equipped with tree glides which provide ease of sliding movement over the rough bark of a tree.

### BRIEF DESCRIPTION OF THE DRAWINGS

FIG. 1 is a side elevational view, taken along line 1-1 of FIG. 2, of a mobile motor-powered climbing tree stand, mounted on a tree;

FIG. 2 is a sectional view of the tree stand taken along line 2-2 of FIG. 1;

FIG. 3 is a perspective view of the tree stand mounted on a tree;

FIG. 4 is a partial front elevational view of the stand from line 44 of FIG. 3, with collapsed legs shown in phantom;

FIG. 5 is a side elevational view of the tree stand in a collapsed or folded configuration;

FIG. 6 is a partial top plan view showing an optional bar and trailer hitch attachment for the front end of the tree stand;

FIG. 7 is a front elevational detail view of one of two belt-cinching members for securing a stand-supporting belt to a tree;

FIG. 8 is a top plan detail view of the lower stand supporting belt equipped with its belt-cinching member and tree glide;

FIG. 9 is a top plan detail view of the upper belt-cinching member of this invention;

FIG. 10 is a side elevational detail view of the lower support belt, belt-cinching member, and tree glides;

FIG. 11 is a side elevational detail view of the belt-cinching member of FIG. 7, with locking pin shown in phantom;

FIG. 12 is a side elevational detail view of one of four tree glides of this invention;

FIG. 13 is a top plan view of a tree glide of this invention with belt pass-through apertures indicated in phantom

### DETAILED DESCRIPTION OF THE PREFERRED EMBODIMENT

With reference to the drawings, particularly to FIG. 1 thereof, the preferred embodiment of the new mobile motor-powered climbing tree stand embodying the concepts of the present invention, designated as 10, will now be described.

The invention 10 can be viewed as comprised of several systems. Those elements comprising the hoisting and support system will be described first. A complex collapsible frame member 11 having a vertical member 12 and a platform member 16 is lifted from the ground by retracting a hoisting cable 18 on a motor-powered crane winch 14 affixed to platform member 16. A cable guide 78 protects cable 18 from fraying by keeping it on-center with respect to the invention 10. The distal end of cable 18 is equipped with hook 20 which engages an eyebolt 36 connected to a belt-cinching assembly 22 securing an upper belt member 24a, preferably made of heavy nylon webbing, to a tree, at the highest level thereon that the user can reach. A lower belt member 24b is secured by a second belt-cinching assembly 34 to the tree slightly below the upper belt member 24a, for supporting the tree stand via safety support cable 38 while the user releases winch tension on upper belt member 24a in order to move it to a higher position on the tree. Hardware stores commonly carry heavy-duty load-securing belt or strap assemblies of nylon webbing with winching belt-tightening mechanisms similar to the belt-cinching members 22 and 34 of this invention.

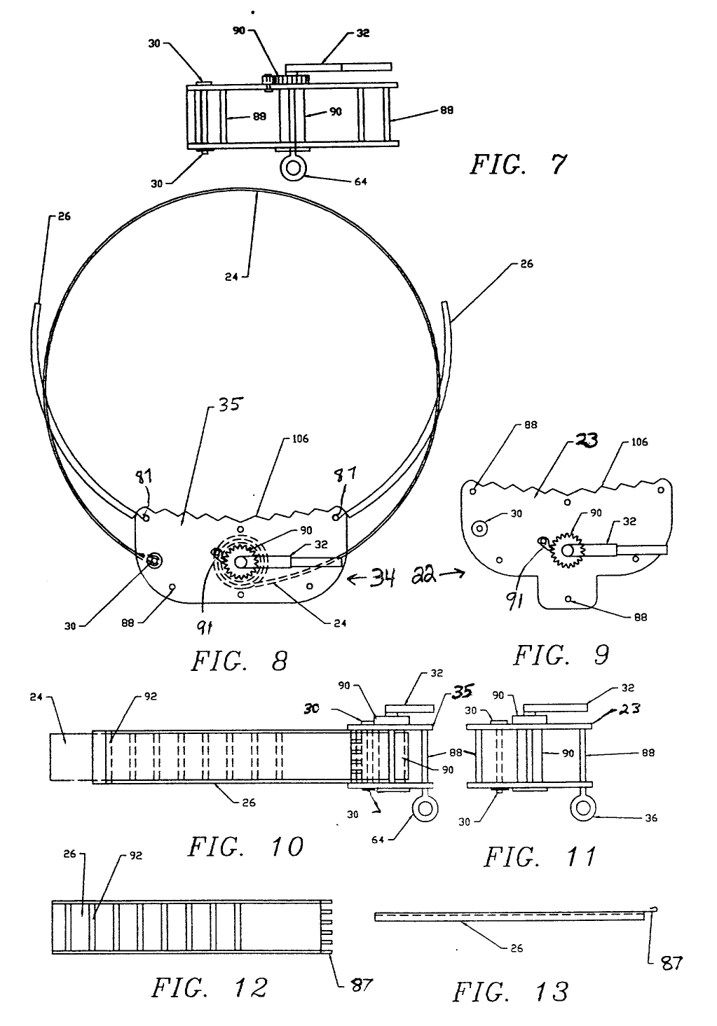

Cable 38 is attached to vertical member 12 at its proximal end to an eyebolt through plate 80. Cable 38, like cable 18, is also equipped at its distal end with a hook 62 which engages eyebolt 64 connected to second belt-cinching assembly 34. Belt-cinching assemblies 22 and 34 are shown in greater detail in FIGS. 7, 8, and 9; they are comprised of pairs of plates 23 and 35 spaced apart by plate spacing pins 88 and ratcheting winch assemblies 90, including pawls 91 and ratcheting winch handles 32, for tightening belt members 24a and 24b. One end of each belt is secured between each pair of matching plates 23 and 35 by pins 30a and 30b. When either belt is tightened to its full extent, the toothed edges 106 of plates 23 and 35 are urged against the tree, thereby preventing slippage of the belts under load. Second belt-cinching assembly 34 does not extend outward from the tree as far as first belt-cinching assembly 22, which allows cable 18 to hang free and clear without getting caught on second belt-cinching assembly 34.

Each belt member 24a and 24b passes around and through a pair of tree glides, 26a and 26b, as shown in FIG. 8, made of hard but flexible plastic to permit ease of sliding the belt members up and down a tree. The tree glides 26a and 26b together with plates 23 and 35 define half circles so that they do not surround the tree and thus can adapt to varying sizes of trees. A plurality of slits 92 as shown in FIGS. 10-12 are provided for passing the belt members 24a and 24b therethrough so that the belt members make contact with the rear half of the tree and may be tightened to fit varying sizes of trees. Tree glides 26a and 26b fasten to belt-cinching members 22 and 34 by means of hooks 87 engaging spacing pins 88, as shown in FIGS. 8, 12, and 13.

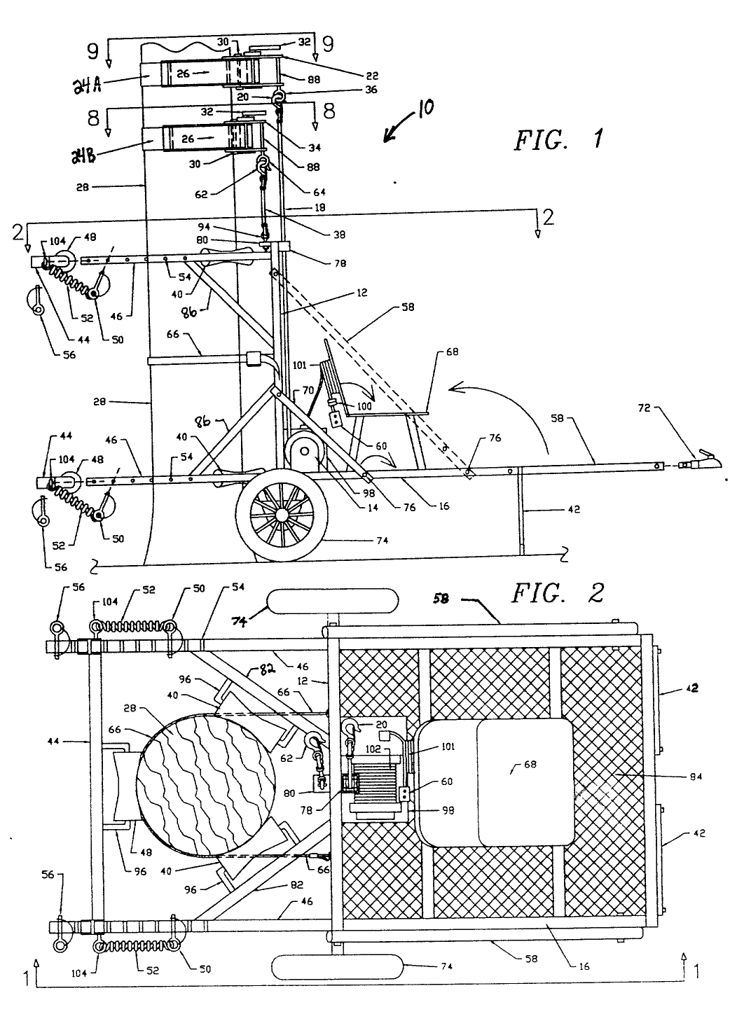

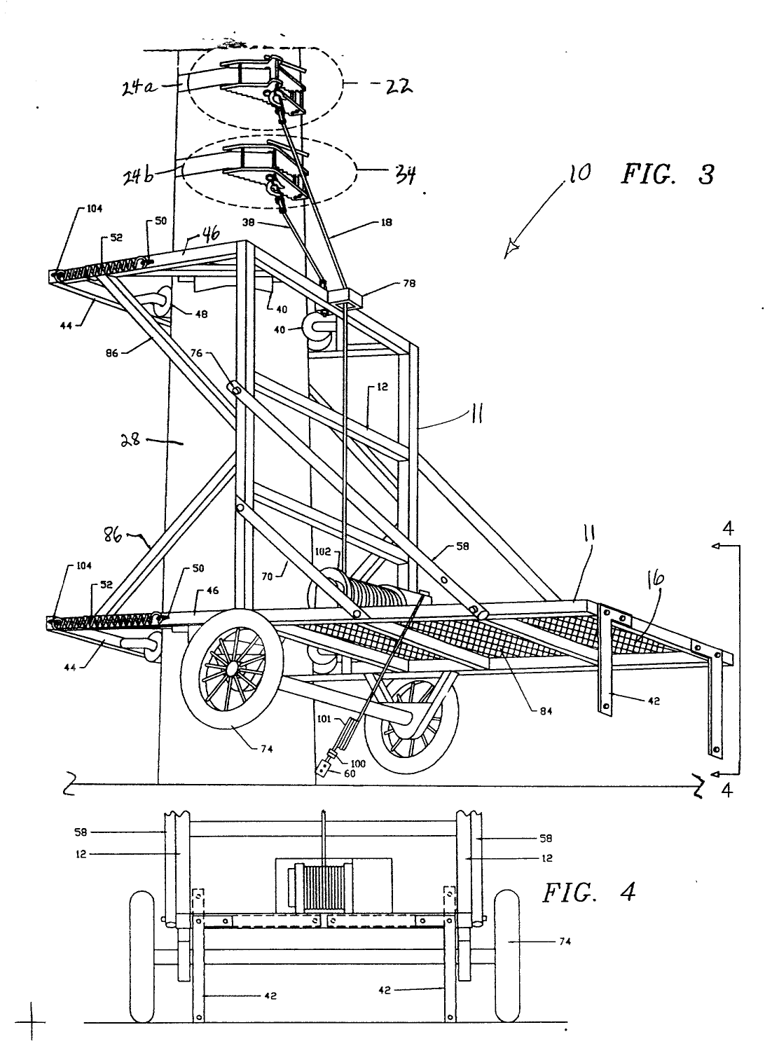

Next, a rolling tree-bracing system for frame member 11 will be described. FIGS. 1-3 show pairs of upper and lower forward keel rollers 40 of the type found on boat trailers, and upper and lower rear keel rollers 48. These permit the stand 10 to roll easily up and down a tree. Parallel upper and lower horizontal support bars 46 are perpendicular to vertical member 12 and extend rearward therefrom on opposite sides of the tree. The forward keel rollers are mounted on axles 96 attached to mounting bars 82 connected between support bars 46 and vertical member 12. Each pair of forward keel rollers and their axles define an angle of roughly 120°. In FIG. 2, it can be seen that each mounting bar 82 defines a hypotenuse of a right triangle, the legs of which are vertical member 12 and upper and lower support bars 46. Upper and lower rear keel rollers 48 on their axles 96 are mounted on upper and lower detachable horizontal rear cross bars 44 which connect upper and lower support bars 46, thereby defining upper and lower tree-enclosing rectangular frames in parallel horizontal planes. Vertical braces 86 connected between support bars 46 and frame member 12 support the rectangular frames in their horizontal planes. Each end of cross bars 44 has a short hollow extension at a right angle to the bar adapted to receive r the end of a support bar 46. Each support bar 46 has a plurality of apertures 54 for receiving a locking pin 50 attached to one end of coil spring 52. Each coil spring 52 is connected at its other end to one end of a horizontal rear cross bar 44, the particular apertures chosen being dependent on the size of the tree to be enclosed. Thus it can be seen, particularly in FIG. 2, that the invention can snugly enclose trees of varying diameters in a range of , yet roll easily up or down along the trunk. Safety locking pins 56 prevent the cross bars 44 from slipping rearward more than four inches under load.

When the invention 10 is at the desired height on the tree trunk, a two-part safety strap combination 66 of heavy-duty nylon webbing, attached to frame member 12 is belted around the tree and cinched in to further secure the invention 10 to the tree.

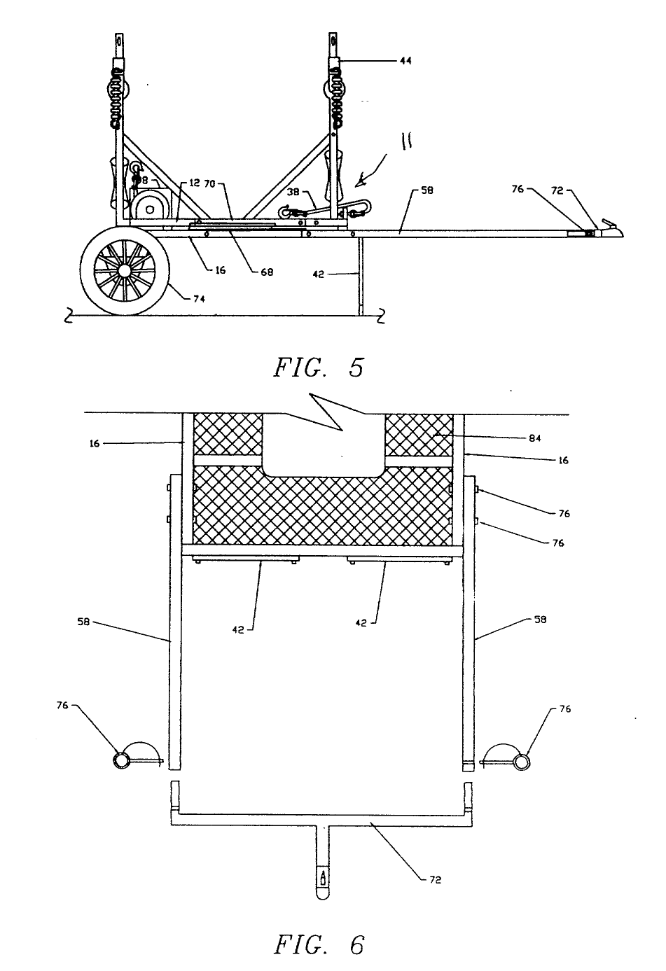

Pivoting bars 58 serve as primary braces maintaining a right angle between framework 12 and platform member 16 when its forward end is swung upward and attached to frame member 12. A secondary brace 70 is also detachable from frame member 12, so that frame member 12, pivotably attached to platform member 16, can be collapsed onto platform member 16 for hauling. FIG. 5 depicts the invention 10 in its collapsed configuration, ready for hauling, supported on its wheels 74 and front legs 42. The user may haul the device manually by grasping pivoting bars 58, or an optional trailer hitch attaching bar 72 can be connected to the forward ends of pivoting bars 58 by means of locking pins 76, as shown in FIG. 6.

Platform member 16 comprises a framework with a floor 84 supporting, in addition to the crane winch 14, a swiveling collapsible chair 68 which permits the user to face in any direction. As shown in FIGS. 1 and 2, floor 84 could be a metal grate which is strong but lightweight.

As shown in FIG. 2, a water-tight winch box 98 houses the crane winch 14 and reduces the noise of the motor. The winch is preferably a Dayton 1000 pound crane winch equipped with a 1000 pound brake system capable of lifting and securing a 1000 pound load. This winch can be powered by a twelve volt battery. The winch is controlled by a switch 60 which can be detached by removing plug 100 from the winch control box switch cable 101. The winch cable 18 also disconnects from winch spool 102, thereby allowing the user to leave first belt-cinching member 22 in place while moving the tree stand 10 to another location. The user could have a number of belt-cinching members with cables attached deployed on various trees, thereby allowing him to quickly move the stand from tree to tree.

The steps in setting up the tree stand 10 are as follows: first, the vertical frame member 12 is raised from its collapsed position and secured upright by pivoting and fastening brace 70. The stand is then backed up to the base 28 of a tree to be climbed until the front keel rollers 40 touch the base 28. Front legs 42 support the front portion of stand 10 while the user slides upper and lower horizontal rear cross bars 44 onto support bars 46 until the rear keel rollers 48 touch the tree base 28. Coil springs 52 are stretched to maximum tension and locking pins 50 then inserted into the nearest apertures 54. Locking pins 56 are then inserted a few inches rearward of the rear cross bars 44 to prevent them from sliding off bars 46 under load. At this point pivoting bars 58 may be swung up and connected to frame member 12 in order to further brace it in its vertical position.

From the platform 16 or the ground, the user assembles upper support belt member 24a with its first belt-cinching member 22 and first tree glide 26a around the tree as high as he can reach and winches it in as tightly as possible. Likewise he places lower support belt member 24b and accessories just below 24a and winches it in tightly. Cable 18 is then released from tension, hook 20 is connected to eyebolt 36, and the winch is activated by switch 60 to retract cable 18 which lifts stand 10 to the point where hook 62 on safety cable 38 may be fastened to eyebolt 64. Tension on cable 18 is then reversed to lower stand 10 until safety cable 38 is supporting the stand. Cable 18 is released from upper belt member 24a which is loosened and then slid upward to the extent of the user's reach, where it is cinched in tightly, and the process of raising the stand is repeated until the desired height is reached. At that point it is desirable to fasten safety strap 66 around the tree to insure against movement of the stand.

Obviously in order to descend, the aforesaid steps can be taken in reverse order. It may be desired to return the stand to the highest location at a later time, in which case the user can descend all the way to the ground leaving the support belts in place at their highest location. The switch control cable 60 can be unwound and from the ground the user may operate the switch to elevate the stand.

While the preferred embodiment of the invention has been shown and described herein, it will be apparent to those skilled the art that a number of modifications can be made to the invention without departing from its spirit and scope as set forth in the following claims.

What is claimed is:

1. A mobile, adjustable, self-elevating tree stand for use on a tree, comprising:
a frame member comprising a vertical portion, a platform portion, and a rolling tree-engaging portion comprising upper and lower rectangular horizontal frames of adjustable depth supporting a plurality of rollers on axles spaced around the girth of the tree and means for urging said rollers against the tree;
means, including a motorized winch with a cable attached to said vertical portion, for raising and lowering said tree stand to and from a desired height on said tree, including a height beyond the reach of a user when standing on the ground;
an upper support belt assembly for releasably securing said cable and tree stand to said tree at a selected elevation;
a lower belt assembly for releasably securing said tree stand at an attained elevation on said tree while said first belt means is released and moved to a higher elevation on said tree, said upper and lower belt assemblies being adjustable to fit a range of tree diameters, and comprised of webbed belting, ratcheting belt-cinching members having serrated tree-gripping portions, and tree glide members partially encircling said tree inside said belting whereby said belt assemblies easily slide up or down the tree when loosened;
a collapsible chair mounted on said platform portion;
an axle and wheels; and
means for detachably connecting said tree stand to a trailer hitch on a motor vehicle.

2. The device according to claim 1 wherein each said rectangular horizontal frame has a front bar, two side bars having rear ends, and a removable rear bar capable of being connected under tension at right angles to said two side bars at a plurality of points spaced from said rear ends of said side bars.

3. A mobile, adjustable, self-elevating tree stand for use on a tree, comprising:
a frame member comprising a vertical portion, a platform portion, and a rolling tree-engaging portion;
means, including a winch with a cable attached to said vertical portion, for raising and lowering said tree stand to and from a desired height on said tree, including a height beyond the reach of the user when standing on the ground;
an upper support belt assembly for releasably securing said cable and tree stand to said tree at a selected elevation; and
a lower belt assembly for releasably securing said tree stand at an attained elevation on said tree while said first belt means is released and moved to a higher elevation on said tree.

4. The device according to claim 3 wherein said rolling tree-engaging portion and said upper and lower belt assemblies adjust to fit a range of tree diameters.

5. The device according to claim 4 wherein said upper and lower belt assemblies are comprised of webbed belting, ratcheting belt-cinching members having serrated tree-gripping portions, and tree glide members partially encircling said tree inside said belting whereby said belt assemblies easily slide up or down the tree when loosened.

6. The device according to claim 5 wherein said tree stand is supported when on the ground by an axle and wheels.

7. The device according to claim 6 wherein said rolling tree-engaging portion of said frame member comprises a rectangular horizontal frame of adjustable depth supporting a plurality of rollers on axles spaced around the girth of the tree and means for urging said rollers against the tree.

8. The device according to claim 7 wherein said vertical portion of said frame member is pivotably connected to said platform portion and is braced in its vertical configuration by pivoting braces, whereby detaching said pivoting braces from said vertical portion allows said vertical portion to be collapsed onto said platform portion and said pivoting braces to extend forward horizontally from said frame member to serve as arms for pushing or pulling said tree stand.

9. The device according to claim 8, further comprising a collapsible chair mounted on said platform portion.

10. The device according to claim 9, further comprising a detachable cross bar connected between said pivoting braces when extended forward horizontally from said frame member, said cross bar having a trailer-hitch socket centered thereon.

11. The device according to claim 3 wherein the means for raising and lowering the tree stand is motor-driven

12. The device according to claim 7 wherein said rolling tree-engaging portion comprises upper and lower parallel rectangular horizontal frames of adjustable depth supporting a plurality of rollers on axles spaced around the girth of the tree, and means for urging said rollers against the tree.

13. The device according to claim 12 wherein each said rectangular horizontal frame has a front bar, two side bars having rear ends, and a removable rear bar capable of being connected under tension at right angles to said two side bars at a plurality of points spaced from said rear ends of said side bars.
